(19) United States
(12) Patent Application Publication
(10) Pub. No.: US 2016/0042101 A1
(43) Pub. Date: Feb. 11, 2016

(54) DATA PREDICTION APPARATUS

(71) Applicant: NEC CORPORATION, Tokyo (JP)

(72) Inventor: Hiroshi YOSHIDA, Tokyo (JP)

(21) Appl. No.: 14/775,485

(22) PCT Filed: Dec. 18, 2013
(86) PCT No.: PCT/JP2013/007424

§ 371 Date: Sep. 11, 2015

(30) Foreign Application Priority Data
Mar. 14, 2013 (JP) 2013-051205

(51) Int. Cl. G06F 17/50; G06F 17/18

(52) U.S. Cl. CPC G06F 17/5009; G06F 17/18

(57) ABSTRACT

This data prediction apparatus is equipped with: a data observation unit that observes the values of time-series data; a model identification unit that uses a stochastic-differential-equation-model to identify a steady-state model and a non-steady-state model, on the basis of past observed time-series data; a likelihood calculation unit that calculates likelihoods, which are values expressing the likelihood of the steady-state model and the non-steady-state model; a mixing ratio calculation unit that calculates the mixing ratio of the steady-state model and the non-steady-state model on the basis of the respective likelihoods of the steady-state model and the non-steady-state model; and a probability distribution prediction unit that predicts the probability distribution of the time-series data on the basis of a prediction model obtained by mixing the steady-state model and the non-steady-state model according to the mixing ratio.

### CROSS-REFERENCE TO RELATED PATENT APPLICATIONS

This application is a National Stage Entry of International Application No. PCT/JP2013/007424, filed Dec. 18, 2013, which claims priority from Japanese Patent Application No. 2013-051205, filed Mar. 14, 2013. The entire contents of the above-referenced applications are expressly incorporated herein by reference.

### TECHNICAL FIELD

The present invention relates to a data prediction apparatus, and more specifically to a data prediction apparatus that predicts values of time series data.

### BACKGROUND ART

The volume of communications through communication networks, such as the Internet and mobile packet networks, has increased according to the spread of cloud services. While communication services are typically provided in a best effort manner on such communication networks, because of cross traffic and radio wave condition, communication throughput, which is a size of data (amount of data) distributed (transmitted) per unit of time, may fluctuate substantially. Thus, for example, the service provider is required to take a countermeasure in advance by predicting the communication throughput. Therefore a communication throughput prediction apparatus that predict such communication throughput have been developed.

A prediction apparatus disclosed in PTL 1 is known as one of communication throughput prediction apparatuses of this type. The prediction apparatus disclosed in PTL 1 determines model parameters of a mathematical model (linear/nonlinear mixed model) based on past time series data and calculates prediction values based on the mathematical model.

A communication throughput prediction apparatus disclosed in NPL 1. is known as one of communication throughput prediction apparatuses of another type. The prediction apparatus disclosed in NPL 1 determines fluctuation processes (steady-state process or non-steady-state process) of communication throughput, and based on a history of such determination, generates a mixed model by mixing a steady-state process model and a non-steady-state process model. The prediction apparatus disclosed in NPL 1 calculates a probability distribution (probability density function) of a future communication throughput based on the mixed model, and calculates stochastic spread (stochastic diffusion) of the future communication throughput by using the probability density function.

### CITATION LIST

### Patent Literature

PTL 1: Japanese Unexamined Patent Application Publication No. 2012-12285

### Non Patent Literature

NPL 1: Yoshida H., Satoda K., Stationarity Analysis and Prediction Model Construction of TCP Throughput by using Application-Level Mechanism, IEICE Technical Report, vol. 112, no. 352, IN2012-128, pp. 39-44, December, 2012.

### SUMMARY OF INVENTION

### Technical Problem

Communication throughput in communications based on TCP/IP (Transmission Control Protocol/Internet Protocol) fluctuates by the moment according to various factors (for example, End-to-End delay, packet loss, cross traffic, radio wave strength in radio communications, and the like) that interact complicatedly.

Regarding such situation, the above-described prediction apparatus disclosed in PTL 1 determines model parameters of the mathematical model (linear/nonlinear mixed model) from past time series data and calculates prediction values based on the mathematical model. The above-described prediction apparatus disclosed in NPL 1 determines fluctuation processes (steady-state process or non-steady-state process) of communication throughput, which fluctuates by the moment as described above, based on observed past time series data of the communication throughput. The prediction apparatus constructs the mixed model into which the steady-state process model and the non-steady-state process model are mixed, based on the observed past time series data of the communication throughput and the history of determination. The prediction apparatus may predict the probability distribution (probability density function) of the future communication throughput based on the mixed model.

However, both prediction technologies described above use a time series model described by a recurrence formula (difference equation) as a prediction model. Thus, there is a problem in that, when time intervals, between respective data points of observed past time series data of the communication throughput, are not equally-spaced, those technologies are not possible to generate the prediction model accurately. Therefore, when the past time series data of the communication throughput have unequally-spaced intervals, those technologies are not possible to predict a future communication throughput accurately. Such a problem may occur in the same manner, in case predicting values of time series data of all types, without limited to predicting the communication throughput.

Accordingly, an object of the present invention is to solve the above-described problem that it is difficult to predict values of time series data highly accurately.

### Solution to Problem

A data prediction apparatus that is an aspect of the present invention has a configuration that includes:

a data observation unit that is configured to observe values of time series data;

a model identification unit that is configured to identify a steady-state model and a non-steady-state model with stochastic-differential-equation-models respectively, based on observed past time series data, the steady-state model representing the time series data when a fluctuation process of time series data is a steady-state process, and the non-steady-state model representing the time series data when a fluctuation process of time series data is a non-steady-state process;

a likelihood calculation unit that is configured to calculate likelihoods, which are values indicating degrees of likelihood of the steady-state model and the non-steady-state model, respectively based on observed past time series data;

a mixing ratio calculation unit that is configured to calculate a mixing ratio of the steady-state model to the non-steady-state model based on the respective likelihoods of the steady-state model and the non-steady-state model; and

a probability distribution prediction unit that is configured to predict a probability distribution of time series data based on a prediction model that is obtained by mixing the steady-state model with the non-steady-state model in accordance with the mixing ratio.

A non-transitory computer-readable recording medium that is another aspect of the present invention is a non-transitory computer-readable recording medium storing a program that allows an information processing device to function as:

a data observation unit that is configured to observe values of time series data;

a model identification unit that is configured to identify a steady-state model and a non-steady-state model with stochastic-differential-equation-models respectively, based on observed past time series data, the steady-state model representing the time series data when a fluctuation process of time series data is a steady-state process, and the non-steady-state model representing the time series data when a fluctuation process of time series data is a non-steady-state process;

a likelihood calculation unit that is configured to calculate likelihoods, which are values indicating degrees of likelihood of the steady-state model and the non-steady-state model, respectively based on observed past time series data;

a mixing ratio calculation unit that is configured to calculate a mixing ratio of the steady-state model to the non-steady-state model based on the respective likelihoods of the steady-state model and the non-steady-state model; and

a probability distribution prediction unit that is configured to predict a probability distribution of time series data based on a prediction model that is obtained by mixing the steady-state model with the non-steady-state model in accordance with the mixing ratio.

A data prediction method that is another aspect of the present invention has a configuration that includes:

observing values of time series data;

identifying a steady-state model and a non-steady-state model with stochastic differential equation models respectively, based on observed past time series data, the steady-state model representing the time series data when a fluctuation process of time series data is a steady-state process, and the non-steady-state model representing the time series data when a fluctuation process of time series data is a non-steady-state process;

calculating likelihoods, which are values indicating degrees of likelihood of the steady-state model and the non-steady-state model, respectively based on observed past time series data;

calculating a mixing ratio of the steady-state model to the non-steady-state model based on the respective likelihoods of the steady-state model and the non-steady-state model; and

predicting a probability distribution of time series data based on a prediction model that is obtained by mixing the steady-state model with the non-steady-state model in accordance with the mixing ratio.

### Advantageous Effects of Invention

The present invention, with a configuration described above, enables to predict values of time series data highly accurately.

### BRIEF DESCRIPTION OF DRAWINGS

FIG. 1 is a functional block diagram illustrating a configuration of a data prediction apparatus of a first exemplary embodiment of the present invention;

FIG. 2 is a graph of the null distribution (cumulative distribution function) that is used in a hypothesis test carried out by a likelihood ratio test unit disclosed in FIG. 1;

FIG. 3 is a schematic view of a probability distribution of future data that is predicted by the data prediction apparatus disclosed in FIG. 1;

FIG. 4 is a graph that compares data prediction accuracy of the data prediction apparatus of the first exemplary embodiment of the present invention with data prediction accuracy in another technology; and

FIG. 5 is a block diagram illustrating a configuration of a data prediction apparatus of Supplemental Note 1 of the present invention.

### DESCRIPTION OF EMBODIMENTS

### First Exemplary Embodiment

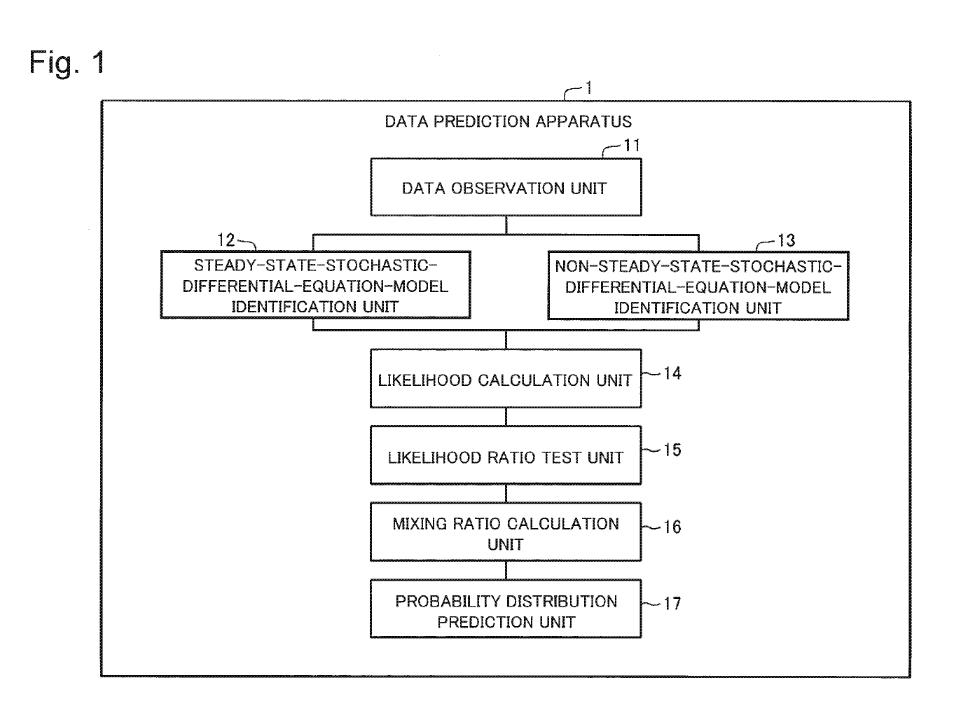

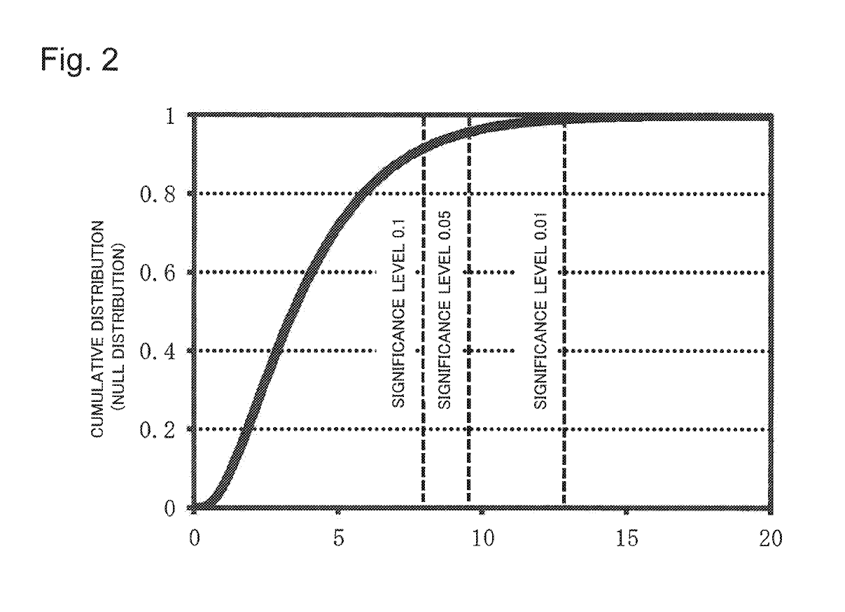

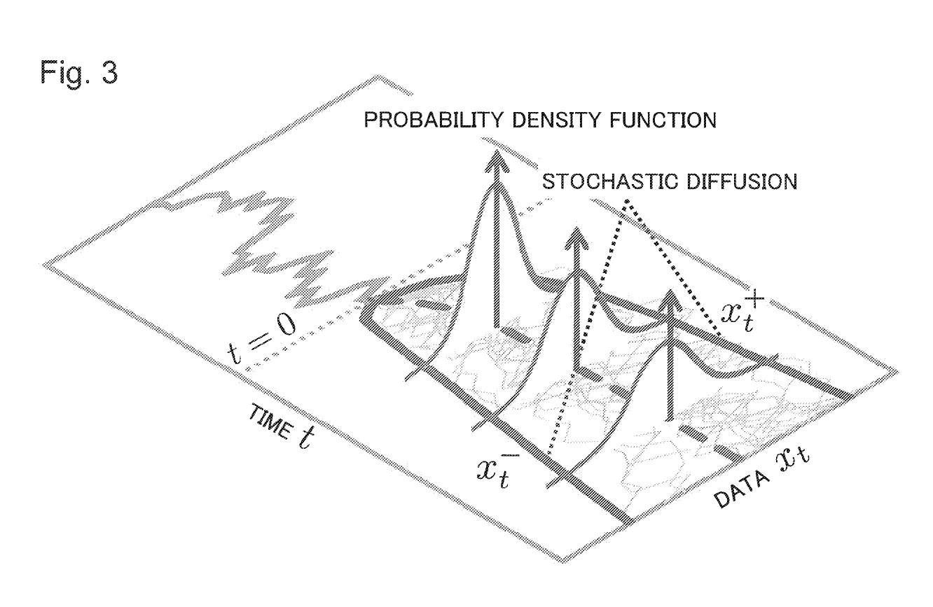

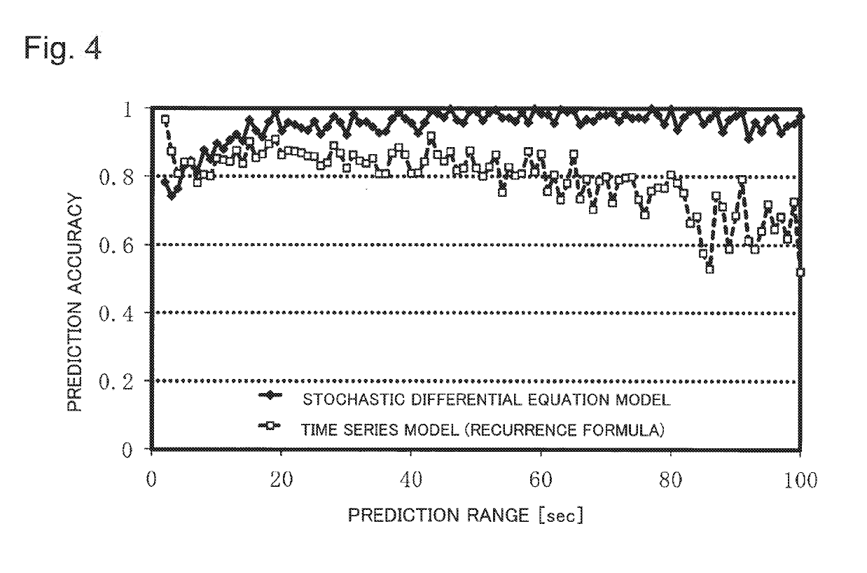

The first exemplary embodiment of the present invention will be described with reference to FIGS. 1 to 4. FIG. 1 is a functional block diagram illustrating a configuration of a data prediction apparatus. FIG. 2 is a graph illustrating information used in the data prediction apparatus. FIG. 3 is a schematic view illustrating a probability distribution of data to be predicted. FIG. 4 is a graph comparing data prediction accuracy in the exemplary embodiment with data prediction accuracy in another technology.

A data prediction apparatus 1 of the present invention is an general information processing apparatus including a processing device and a memory device. The data prediction apparatus 1, as illustrated in FIG. 1, includes the following components, which may be realized by installing a program in the processing device. That is, the data prediction apparatus 1 includes a data observation unit 11. The data prediction apparatus 1 also includes a steady-state-stochastic-differential-equation-model identification unit 12. The data prediction apparatus 1 also includes a non-steady-state-stochastic-differential-equation-model identification unit 13. The data prediction apparatus 1 also includes a likelihood calculation unit 14. The data prediction apparatus 1 also includes a likelihood ratio test unit 15. The data prediction apparatus 1 also includes a mixing ratio calculation unit 16. The data prediction apparatus 1 also includes a probability distribution prediction unit 17. Configurations and operations of the respective components will be described below.

[Data Observation Unit 11]

The data observation unit 11 (data observation means) observes time series data {xₜ} to be target for observation. The time series data is a data sequence of observed data of a random variable that fluctuates as the time elapses. For example, it is assumed a case, in which the time series data to be observation target are communication throughput data, and values of x=5 [Mbps (Mega bit per second)], x=3 [Mbps], and x=7 [Mbps] are observed at the times t=0 [sec], t=1.5 [sec], and t=4.1 [sec], respectively. In this case, observed time series data are {x₀=5, x_{1.5}=3, x_{4.1}=7}. The targeted time series data for the data prediction apparatus are not limited to communication throughput data. The targeted time series data for the data prediction apparatus may be any type of time series data.

In well-known data prediction apparatuses, time intervals, between any adjacent data in observed time series data, are required to be equal interval. However, in the data prediction apparatus of the present invention, time intervals between adjacent data may not be equal interval, as described in the example above. This feature is caused by that a data model at a certain time is identified with a stochastic differential equation model (referred as stochastic-differential-equation-model), as described later.

[Steady-State-Stochastic-Differential-Equation-Model Identification Unit 12]

The steady-state-stochastic-differential-equation-model identification unit 12 (model identification means) identifies a stochastic-differential-equation-model (steady-state-stochastic-differential-equation-model (steady-state model)) that represents the time series data when a fluctuation process of the time series data is a steady-state process, based on the time series data observed by the above-described data observation unit 11.

In the exemplary embodiment, a stochastic-differential-equation-model that is expressed by the equation (1) is used for the stochastic-differential-equation-model that represents time series data.

dxₜ=a(b−xₜ)dt+σdBₜ (1)

The above-described “xₜ” is a targeted random variable. The above-described “a” and “b”, “σ”, and “Bₜ” are real constants, a positive constant, and a standard Brownian motion, respectively. The equation (1) is a stochastic-differential-equation-model that is derived by replacing difference expressions in the time series model in the above-described NPL 1, which is expressed by a recurrence formula (difference equation), with corresponding differential expressions. In this way, it is possible to obtain more accurate data prediction values by narrowing time intervals in the time series model to an infinitesimal, even when intervals between observed time series data are unequal.

It is known that the stochastic-differential-equation-model expressed by the equation (1) becomes the steady-state process when “a”>0, and becomes the non-steady-state process when “a”≦0. Thus, the steady-state-stochastic-differential-equation-model identification unit 12 identifies a steady-state-stochastic-differential-equation-model for the case of “a”>0 in the equation (1). This is equivalent to estimating “a”, “b”, and “σ”, which are parameters of the steady-state-stochastic-differential-equation-model expressed by the equation (1). An identification method to identify the steady-state-stochastic-differential-equation-model will be described below in detail.

The stochastic-differential-equation-model expressed by the equation (1) is a stochastic process that is referred to as Ornstein-Uhlenbeck process. Such a stochastic process is, in particular, when “a”, “b”, and “σ” are constants, referred to as Vasicek model, and a general solution has been found. When “xₛ” is observed at the time “s”, the general solution of “xₜ” at the time “t” (>“s”) after time “s” is expressed by the equation (2).

xₜ=b+e^{-a(t-s)}(xₛ−b)+e^{-a(t-s)}∫_{S}^{t}e^{aτ}dB_{τ} (2)

Based on the general solution expressed by the equation (2), when “xₛ” is observed at the time “s” in the same way, a conditional expectation and a conditional variance of “xₜ” at the time “t” (>“s”) after the time “s” are calculated by the equation (3) and the equation (4), respectively.

$$\begin{matrix}E [ {x}_{t} \vert {x}_{s} ] = {x}_{s} {e}^{- a ( t - s )} + b ( 1 - {e}^{- a ( t - s )} ) & ( 3 ) \\ V [ {x}_{t} \vert {x}_{s} ] = \frac{{σ}^{2}}{2 a} ( 1 - {e}^{- 2 a ( t - s )} ) & ( 4 )\end{matrix}$$

Since an Ornstein-Uhlenbeck process is included in a class of Gaussian processes, a probability distribution at each time of the general solution expressed by the equation (2) is a Gaussian distribution. Thus, when E[xₜ|xₛ] in the equation (3) and V[xₜ|xₛ] in the equation (4) are represented as “μ_{s,t}” and “σ²_{s,t}” anew respectively, in the case in which “xₛ” is observed at the time “s”, a conditional probability distribution function of “xₜ” at the time “t” (>“s”) after the time “s” is expressed by the equation (5).

$$f ( {x}_{t} \vert {x}_{s} ) = \frac{1}{\sqrt{2 {πσ}_{s , t}^{2}}} exp ( - \frac{( {x}_{t} - {μ}_{s , t} )}{2 {σ}_{s , t}^{2}} ) \qquad ( 5 )$$

As described above, the steady-state-stochastic-differential-equation-model identification unit 12 is intended to estimate “a”, “b”, and “σ”, which are model parameters. In the exemplary embodiment, a method to estimate the above-described model parameters “a”, “b”, and “σ” by using the maximum likelihood estimation method will be described.

First, it is assumed that n past time series data {“xₜ₁”, “xₜ₂”, . . . , “xₜₙ”} (“t₁”<“t₂”< . . . <“tₙ”) are observed. Time intervals between adjacent data points (“tᵢ₊₁”-“tᵢ”) (i=1, 2, . . . , “n”−1) may be unequally-spaced. Since the conditional probability distribution function of the general solution for the steady-state-stochastic-differential-equation-model is expressed by the equation (5), a likelihood function L, when the above-described “n” past time series data are observed, is expressed by the equation (6).

$$L = {\prod }_{i = 2}^{n} \{ \frac{1}{\sqrt{2 {πσ}_{{t}_{i} , {t}_{i - 1}}^{2}}} exp ( - \frac{( {x}_{t} - {μ}_{{t}_{i} , {t}_{i - 1}} )}{2 {σ}_{{t}_{i} , {t}_{i - 1}}^{2}} ) \} \qquad ( 6 )$$

Since “μ_{ti,ti-1}” and “σ_{ti,ti-1}” in the above-described equation (6) are functions of “a”, “b”, and “σ” as expressed by the equations (3) and (4), respectively, the likelihood function L is also a function of “a”, “b”, and “σ”. In the maximum likelihood estimation method, values of “a”, “b”, and “σ” that maximize the likelihood function L are calculated.

However, it is difficult to analytically calculate the values of “a”, “b”, and “σ” that maximize the likelihood function L. Therefore, a method to calculate numerically the values of “a”, “b”, and “σ” that maximize the likelihood function L, will be described in the exemplary embodiment.

First, the logarithm ln(L) of the likelihood function L in the equation (6) is calculated by the equation (7). It is, however, assumed that Δtᵢ=“tᵢ”−“tᵢ₋₁”.

$$ln L = - \frac{n - 1}{2} ln 2 π - \frac{1}{2} {\sum }_{i = 2}^{n} ln \{ \frac{{σ}^{2}}{2 a} ( 1 - {e}^{- 2 a Δ {t}_{i}} ) \} - \frac{1}{2} {\sum }_{i = 2}^{n} \frac{2 a {\{ {x}_{{t}_{i}} - b - ( {x}_{{t}_{i - 1}} - b ) {e}^{- a Δ {t}_{i}} \}}^{2}}{{σ}^{2} ( 1 - {e}^{- 2 a Δ {t}_{i}} )} \qquad ( 7 )$$

Maximizing the likelihood function L is equivalent to maximizing ln L, which is the logarithm of the likelihood function L. Since the first term on the right-hand side of the equation (7) is a term that is independent of “a”, “b”, and “σ”, the sum of the second term and the third term may be maximized.

Functions that are derived by eliminating (−½) from the second and third terms on the right-hand side of the equation (7) are defined as the equations (8) and (9), respectively.

$$\begin{matrix}F = {\sum }_{i = 2}^{n} ln \{ \frac{{σ}^{2}}{2 a} ( 1 - {e}^{- 2 a Δ {t}_{i}} ) \} & ( 8 ) \\ G = {\sum }_{i = 2}^{n} \frac{2 a {\{ {x}_{{t}_{i}} - b - ( {x}_{{t}_{i - 1}} - b ) {e}^{- a Δ {t}_{i}} \}}^{2}}{{σ}^{2} ( 1 - {e}^{- 2 a Δ {t}_{i}} )} & ( 9 )\end{matrix}$$

In consequence, maximizing the likelihood function L is equivalent to minimizing the above-described (F+G). The exemplary embodiment employs a quasi-Newton method as a method to calculate “a”, “b”, and “σ” that minimize (F+G). Specific processing steps of the quasi-Newton method may be as follows.

(Preparation) Set θ=[a b σ]^{T} (“T” represents a transposition).
(Step 0) Set an appropriate initial value “θ₀”, and assume that an initial “B₀” is a (3×3) identity matrix.
(Step 1) Calculate a search direction vector “d”, by solving a set of simultaneous linear equations that is expressed by the equation (10).

Bₖd=−∇(F+G)(θₖ) (10),

where ∇(F+G) is defined by the equation (11).

$$\begin{matrix}[ Equation ( 11 ) ] & \\ ∇ ( F + G ) = [ \begin{matrix}\frac{\partial F}{\partial a} + \frac{\partial G}{\partial a} \\ \frac{\partial F}{\partial b} + \frac{\partial G}{\partial b} \\ \frac{\partial F}{\partial σ} + \frac{\partial G}{\partial σ}\end{matrix} ] . & ( 11 )\end{matrix}$$

(Step 2) Calculate a step size in the search, based on the Armijo condition, which will be described in the following Steps 2.1 to 2.4.
(Step 2.1) Set (β_{k,0}=1, i=0, 0<ξ<1, and 0<τ<1).
(Step 2.2) If the Armijo condition expressed by the equation (12) is satisfied, proceed to Step 2.4. Otherwise, proceed to Step 2.3.

(F+G)(θₖ+β_{k,i}dₖ)≦(F+G)(θₖ)+ξβ_{k,i}∇(F+G)(θₖ)^{T}dₖ (12)

(Step 2.3) Set (β_{k,i+1}=τβ_{k,i} and i:=i+1), and return to Step 2.2.
(Step 2.4) Set (αₖ=β_{k,i}).
(Step 3) Update “θ” by using the equation (13).

θₖ₊₁=θₖ+αₖdₖ (13)

(Step 4) If a stopping condition is satisfied, finish the processing steps. Otherwise, proceed to Step 5. The stopping conditions may be represented by the equations (14) or (15).

∥∇(F+G)(θₖ)∥<ε (14)

∥θₖ₊₁−θₖ∥<ε (15)

(Step 5) Calculate the equations (16) and (17).

sₖ=θₖ₊₁−θₖ (16)

yₖ=∇(F+G)(θₖ₊₁)−∇(F+G)(θₖ) (17)

(Step 6) Update the matrix “Bₖ” by using the equation (18) (BFGS formula).

$${B}_{k + 1} = {B}_{k} - \frac{{B}_{k} {{s}_{k} ( {B}_{k} {s}_{k} )}^{T}}{{s}_{k}^{T} {B}_{k} {s}_{k}} + \frac{{y}_{k} {y}_{k}^{T}}{{s}_{k}^{T} {y}_{k}} \qquad ( 18 )$$

(Step 7) Set k:=k+1 and return to Step 1.

It is possible to calculate (θ=[a b σ]^{T}) that maximizes (F+G) by carrying out the above-described Steps 1 to 7.

Although, in the above-described quasi-Newton method, the Armijo condition is used to calculate the step size in the search in Step 2, the Wolfe condition may also be used. The “H formula”, in which the calculation is carried out based on an inverse matrix “Hₖ” of the matrix “Bₖ” in substitution for the matrix “Bₖ” in the BFGS formula, may also be used.

[Non-Steady-State-Stochastic-Differential-Equation-Model Identification Unit 13]

The non-steady-state-stochastic-differential-equation-model identification unit 13 (model identification means) identifies a non-steady-state-stochastic-differential-equation-model (non-steady-state model), based on the time series data observed by the afore-described data observation unit 11.

Such non-steady-state-stochastic-differential-equation-model (non-steady-state model) is a stochastic-differential-equation-model that represents the time series data when the fluctuation process of the above-described time series data is a non-steady-state process. The non-steady-state-stochastic-differential-equation-model identification unit 13 estimates model parameters of the non-steady-state-stochastic-differential-equation-model.

As described above, the stochastic differential equation that is a base for the model of the time series data is expressed by the equation (1). The stochastic differential equation expressed by the equation (1) represents non-steady-state when “a”≦0. However, since the stochastic-differential-equation-model defined in range of “a”<0 becomes a process that rapidly diverges to infinity. Therefore such region of stochastic-differential-equation-model is inadequate for prediction of almost all bounded time series data. Thus, only the case of “a”=0 may be considered for the non-steady-state-stochastic-differential-equation-model. In this case, the non-steady-state-stochastic-differential-equation-model is expressed by the equation (19).

dxₜ=σdBₜ (19)

The stochastic-differential-equation-model expressed by the equation (19) is equivalent to a Brownian motion model, the model parameter of which is only the parameter “σ”. Thus, to identify the non-steady-state-stochastic-differential-equation-model, only “σ” may be estimated. In a similar manner to the steady-state-stochastic-differential-equation-model identification unit 12, σ is estimated by using the maximum likelihood estimation method. A general solution of the non-steady-state-stochastic-differential-equation-model expressed by the equation (19) is expressed by the equation (20).

xₜ=σBₜ (20)

A conditional expectation, a conditional variance, and a conditional probability distribution function of “xₜ” at the time “t” (>“s”), under the condition that “xₛ” is observed at the time “s”, are expressed by the equations (21), (22), and (23), respectively.

$$\begin{matrix}E [ {x}_{t} \vert {x}_{s} ] = {x}_{s} & ( 21 ) \\ V [ {x}_{t} \vert {x}_{s} ] = {σ}^{2} ( t - s ) & ( 22 ) \\ f ( {x}_{t} \vert {x}_{s} ) = \frac{1}{\sqrt{2 {πσ}^{2} ( t - s )}} exp ( - \frac{{( {x}_{t} - {x}_{s} )}^{2}}{2 {σ}^{2} ( t - s )} ) & ( 23 )\end{matrix}$$

In this case, the likelihood function “L”, when “n” past time series data {“xₜ₁”, “xₜ₂”, . . . , “xₜₙ”} (“t₁”<“t₂”< . . . <“tₙ”) are observed, is expressed by the equation (24). In this case, it is assumed that (Δtᵢ=tᵢ−tᵢ₋₁).

$$L = {\prod }_{i = 2}^{n} \{ \frac{1}{\sqrt{2 {πσ}^{2} Δ {t}_{i}}} exp ( - \frac{( {x}_{t} - {x}_{s} )}{2 {σ}^{2} Δ {t}_{i}} ) \} \qquad ( 24 )$$

A value of “σ” that maximizes the logarithm (ln L) of the likelihood function “L” expressed by the equation (24) is calculated as following. The value of “σ” can be calculated analytically and is expressed by the equation (25).

$$σ = \frac{1}{n - 1} {\sum }_{k = 2}^{n} \frac{{( {x}_{{t}_{i}} - {x}_{{t}_{i - 1}} )}^{2}}{Δ {t}_{i}} \qquad ( 25 )$$

[Likelihood Calculation Unit 14]

The likelihood calculation unit 14 (likelihood calculation means) calculates likelihoods, which are values that represents the degrees of likelihood of stochastic-differential-equation-models identified by the above-described steady-state-stochastic-differential-equation-model identification unit 12 and the above-described non-steady-state-stochastic-differential-equation-model identification unit 13, based on the observed time series data, respectively. The likelihoods of the steady-state-stochastic-differential-equation-model may be obtained through calculation based on equation (6), and the likelihood of the non-steady-state-stochastic-differential-equation-model may be obtained through calculation based on the equation (24), respectively.

[Likelihood Ratio Test Unit 15]

The likelihood ratio test unit 15 (test means) tests whether the observed time series data conform to the steady-state-stochastic-differential-equation-model or to the non-steady-state-stochastic-differential-equation-model, by using a hypothesis test. The likelihood ratio test unit 15 executes above described test based on a ratio of the likelihood of the steady-state-stochastic-differential-equation-model to the likelihood of the non-steady-state-stochastic-differential-equation-model, both of which are calculated by the above-described likelihood calculation unit 14,

In the exemplary embodiment, a hypothesis that “the observed time series data are data generated by the non-steady-state-stochastic-differential-equation-model” is tested, by considering the hypothesis as the null hypothesis. In this case, the alternative hypothesis is that “the observed time series data are data generated by the steady-state-stochastic-differential-equation-model”.

Specifically, in the exemplary embodiment, a test statistic “R” (equation (27)), which is calculated by multiplying the logarithm of a likelihood ratio “Λ” (equation (26)), which is defined as below, by (−2), is used in the test. In this case, “Lₛ” represents the likelihood of the steady-state-stochastic-differential-equation-model (equation (6)) and sup{Lₛ} represents the supremum thereof. “Lₙ” represents the likelihood of the non-steady-state-stochastic-differential-equation-model (equation (24)), and sup{Lₙ} represents the supremum thereof.

$$\begin{matrix}Λ = \frac{sup \{ {L}_{n} \}}{sup \{ {L}_{s} \}} & ( 26 ) \\ R = - 2 ln Λ & ( 27 )\end{matrix}$$

For sup{Lₛ} and sup{Lₙ}, the likelihoods calculated by the likelihood ratio test unit 15 may be used, respectively. That is, because the likelihoods calculated by the likelihood ratio test unit 15 are likelihoods that are calculated based on the model parameters that maximize the respective likelihood functions (the equations (6) and (24)), and the likelihoods may be considered the supremum.

The supremum sup{Lₛ} for the likelihood of the steady-state-stochastic-differential-equation-model is always greater than or equal to the supremum sup{Lₙ} for the likelihood of the non-steady-state-stochastic-differential-equation-model (sup{Lₛ}≧sup{Lₙ}). That is because, while the number of model parameters of the steady-state-stochastic-differential-equation-model is three (“a”, “b”, and “σ”), the number of model parameters of the non-steady-state-stochastic-differential-equation-model is one (only “σ”). Thus, the statistic “R” becomes a non-negative real number as expressed by the equation (28).

R=2(sup{Lₛ}−sup{Lₙ})≧0 (28)

In the likelihood ratio test, when the null hypothesis (a hypothesis that the non-steady-state-stochastic-differential-equation-model is applicable) is false, supremum of the likelihood sup{Lₛ} of the steady-state-stochastic-differential-equation-model becomes greater than supremum of the likelihood sup{Lₙ} of the non-steady-state-stochastic-differential-equation-model. By using a characteristic that the value of the statistic “R” increases as the above-described result, when the statistic “R” becomes greater than a predetermined value, the null hypothesis is rejected and the alternative hypothesis (a hypothesis that the steady-state-stochastic-differential-equation-model is applicable) is accepted. On the other hand, when the value of the statistic “R” is less than or equal to the predetermined value, the null hypothesis is not rejected, and is accepted.

A threshold of whether or not the null hypothesis is rejected depends on a distribution (referred to as null distribution) of the statistic “R” when the null hypothesis is true, and on a predetermined significance level. Since it is difficult to calculate the null distribution analytically, in the exemplary embodiment, a distribution calculated by a Monte Carlo simulation is used as the null distribution. FIG. 2 illustrates the null distribution (cumulative distribution function) calculated by a Monte Carlo simulation. The null distribution is obtained by repeating three million trials to generate one hundred points of time series data and calculating statistics “R” under the null hypothesis (the non-steady-state-stochastic-differential-equation-model). The null hypothesis may be rejected when (R>7.6) in case the significance level is 0.1, when (R>9.2) in case the significance level is 0.05, and when (R>12.8) in case the significance level is 0.01, respectively.

The likelihood ratio test unit 15 prepares the null distribution and the significance level or the null distribution and the threshold value that is obtained based on the significance level (for example, the threshold value of 7.6 for a significance level of 0.1), which were described above, in advance. The likelihood ratio test unit 15 calculates the statistic “R” from observed time series data based on the equations (26) and (27). The likelihood ratio test unit 15, based on the statistic “R” and the above-described threshold value, accepts the hypothesis that the steady-state-stochastic-differential-equation-model is applicable or accepts the hypothesis that the non-steady-state-stochastic-differential-equation-model is applicable.

[Mixing Ratio Calculation Unit 16]

The mixing ratio calculation unit 16 (mixing ratio calculation means) calculates a mixing ratio that indicates a ratio for mixing the steady-state-stochastic-differential-equation-model identified by the steady-state-stochastic-differential-equation-model identification unit 12 with the non-steady-state-stochastic-differential-equation-model identified by the above-described non-steady-state-stochastic-differential-equation-model identification unit 13. The mixing ratio calculation unit 16 calculates the mixing ratio, based on a history of the above-described results of the test by the likelihood ratio test unit 15.

A random variable “uₜ” is defined as below ((equation (29)). The random variable “uₜ” is defined to take a value of 0 when the steady-state-stochastic-differential-equation-model is accepted, and to take a value of 1 when the non-steady-state-stochastic-differential-equation-model is accepted, as a result of the test carried out by the above-described likelihood ratio test unit 15.

$$\begin{matrix}[ Equation ( 29 ) ] & \\ {u}_{t} = \{ \begin{matrix}0 & ( accept steady \text{-} state model ) \\ 1 & ( accept non \text{-} steady \text{-} state model )\end{matrix} & ( 29 )\end{matrix}$$

In the exemplary embodiment, as in the equation (30) described below, an exponential weighted moving average “λₜ” of the above-described “uₜ” is employed as the mixing ratio. In the equation (30), “γ” is a smoothing coefficient for the exponential weighted moving average, and (0≦γ≦1) is satisfied.

λₜ_{ₙ}=(1−γ)λₜ_{ₙ₋₁}+γuₜ_{ₙ} (30)

The mixing ratio calculation unit 16 (mixing ratio calculation means), based on the obtained mixing ratio “λₜ”, mixes the steady-state-stochastic-differential-equation-model with the definition expressed by the equation (29), the ratio of the non-steady-state-stochastic-differential-equation-model becomes consistent with “λₜ”.

[Probability Distribution Prediction Unit 17]

The probability distribution prediction unit 17 (probability distribution prediction means) predicts a probability distribution of future data. The probability distribution prediction unit 17 predicts the probability distribution, on the basis of the above-described mixing ratio calculated by the mixing ratio calculation unit 16, the steady-state-stochastic-differential-equation-model identified by the steady-state-stochastic-differential-equation-model identification unit 12 based on the mixing ratio, and the non-steady-state-stochastic-differential-equation-model identified by the non-steady-state-stochastic-differential-equation-model identification unit 13.

A probability density function of the random variable in the steady-state-stochastic-differential-equation-model expressed by the equation (5) is represented anew as f(xₜ). A probability density function of the random variable in the non-steady-state-stochastic-differential-equation-model expressed by the equation (23) is represented anew as g(xₜ). Then, based on the above-described mixing ratio “λₜ” calculated by the mixing ratio calculation unit 16, a probability density function h(xₜ) of the random variable “xₜ” in a mixed model is expressed by the equation (31). The probability density function h(xₜ) represents a probability distribution of future data.

h(xₜ)=(1−λₜ)f(xₜ)+λₜg(xₜ) (31)

The equation (31) expresses a mixed normal distribution into which two normal distribution are mixed together, and an expectation Eₘᵢₓ[xₜ] and a variance Vₘᵢₓ[xₜ] are calculated by the equations (32) and (33), respectively. In the equations (32) and (33), Eₛ[xₜ] and Vₛ[xₜ] are the expectation and the variance of “xₜ” in the steady-state-stochastic-differential-equation-model, respectively. Eₙ[xₜ] and Vₙ[xₜ] are the expectation and the variance of “xₜ” in the non-steady-state-stochastic-differential-equation-model, respectively.

Eₘᵢₓ[xₜ]=(1−λₜ)Eₛ[xₜ]+λₜEₙ[xₜ] (32)

Vₘᵢₓ[xₜ]=(1−λₜ)(Eₛ[xₜ]²+Vₛ[xₜ])+λₜ(Eₙ[xₜ]²+Vₙ[xₜ])−Eₘᵢₓ[xₜ]² (33)

### Advantageous Effects of Invention

In predicting future data values, there is a case where it is convenient to have a criterion with regard to a range in which the future data exist probabilistically. Such probabilistic fluctuation range is referred to as stochastic diffusion and is defined by the equation (34).

xₜ^{±}=Eₘᵢₓ[xₜ]±α\sqrt{Vₘᵢₙ[xₜ]} (34)

The stochastic diffusion expressed by the equation (34) may take a value that is calculated by adding a value, which is a constant times (α times) the standard deviation, to the expectation. Or the stochastic diffusion may take a value that is calculated by subtracting a value, which is a constant times (α times) the standard deviation, from the expectation. FIG. 3 is a schematic view illustrating the probability density function, the expectation, and the stochastic diffusion of the prediction model. The stochastic diffusion diffuses as the time elapses, and this indicates uncertainty in predicted values of data over time. The higher the ratio of the non-steady-state-stochastic-differential-equation-model becomes, the wider the stochastic diffusion diffuses. And the higher the ratio of the steady-state-stochastic-differential-equation-model becomes, the narrower the stochastic diffusion diffuses.

Regarding prediction accuracy in the above-described stochastic diffusion, prediction accuracy in the stochastic diffusion predicted by the prediction method using the stochastic-differential-equation-model of the exemplary embodiment of the present invention, and prediction accuracy in the stochastic diffusion predicted by using the time series model (recurrence formula), which is a well-known technology, are illustrated in FIG. 4. In the example in FIG. 4, diffusion values are calculated from a histogram of variation in actual data values. Then values, that is calculated by subtracting error value (%) between the calculated diffusion values and the predicted stochastic diffusion from 100(%), are used as predicted values. The prediction target data are time series data of communication throughput in a mobile network. Specifically the prediction target data are unequal interval time series data, with time intervals between adjacent data points following an exponential distribution of which average is 2 seconds. FIG. 4 illustrates that the prediction method using the stochastic-differential-equation-model achieves the higher prediction accuracy.

<Supplemental Note>

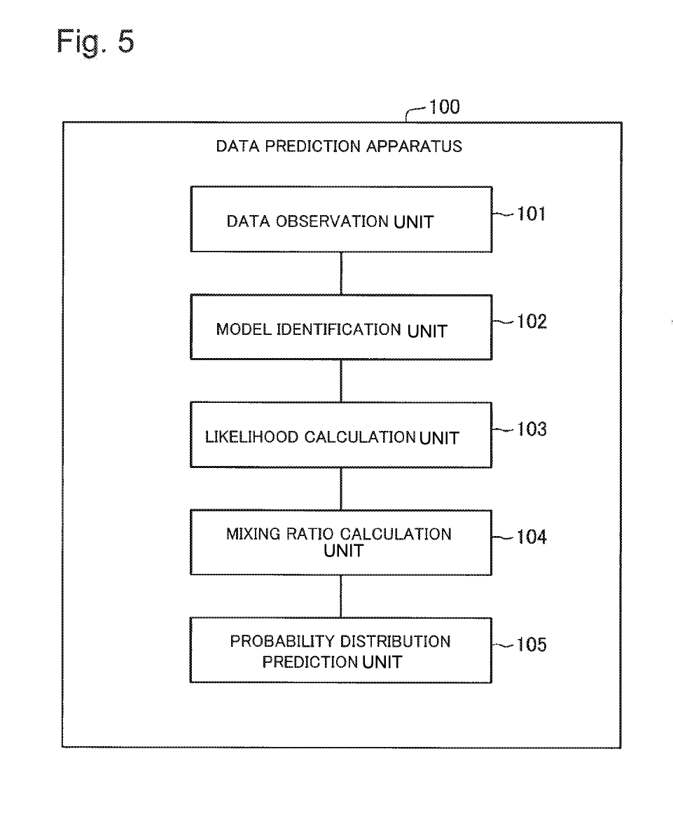

All or part of the exemplary embodiment described above may be described as in the following Supplemental Notes. A summary of configurations of the data prediction apparatus (refer to FIG. 5), the program, and the data prediction method of the present invention will be described below. However, the present invention is not limited to the following configurations.

### (Supplemental Note 1)

A data prediction apparatus 100, including:

a data observation means 101 that observes values of time series data;

a model identification means 102 that identifies a steady-state model, which represents the time series data when a fluctuation process of time series data is a steady-state process, and a non-steady-state model, which represents the time series data when a fluctuation process of time series data is a non-steady-state process, with stochastic-differential-equation-models respectively, based on observed past time series data;

a likelihood calculation means 103 that calculates likelihoods, which are values indicating degrees of likelihood of the steady-state model and the non-steady-state model, individually based on observed past time series data;

a mixing ratio calculation means 104 that calculates a mixing ratio of the steady-state model to the non-steady-state model based on the respective likelihoods of the steady-state model and the non-steady-state model; and

a probability distribution prediction means 105 that predicts a probability distribution of time series data based on a prediction model that is obtained by mixing the steady-state model with the non-steady-state model in accordance with the mixing ratio.

### (Supplemental Note 2)

The data prediction apparatus according to Supplemental Note 1,

wherein the model identification means identifies the steady-state model and the non-steady-state model respectively with different stochastic-differential-equation-models.

### (Supplemental Note 3)

The data prediction apparatus according to Supplemental Note 1 or 2,

wherein the model identification means identifies the steady-state model with a Vasicek model, and identifies the non-steady-state model with a Brownian motion model.

### (Supplemental Note 4)

The data prediction apparatus according to any one of Supplemental Notes 1 to 3, further including:

a test means that executes a test for whether observed time series data conform to the steady-state model or the non-steady-state model based on a ratio of the likelihood of the steady-state model to the likelihood of the non-steady-state model,

wherein the mixing ratio calculation means calculates the mixing ratio of the steady-state model to the non-steady-state model based on a result of the test.

### (Supplemental Note 5)

The data prediction apparatus according to Supplemental Note 4,

wherein the test means executes a hypothesis test, in the hypothesis test, a hypothesis that observed time series data conform to the non-steady-state model being defined as a null hypothesis, and a hypothesis that observed time series data conform the steady-state model being defined as an alternative hypothesis.

### (Supplemental Note 6)

The data prediction apparatus according to Supplemental Note 4 or 5,

wherein, as a result of the test, the mixing ratio calculation means sets a variable that takes a value of 0 when the observed time series data conform to the steady-state model and a value of 1 when the he observed time series data conform to non-steady-state model, and calculates a value by smoothing the variable, as the mixing ratio.

### (Supplemental Note 7)

A program that allows an information processing apparatus to function as:

a data observation means that observes values of time series data;

a model identification means that identifies a steady-state model, which represents the time series data when a fluctuation process of time series data is a steady-state process, and a non-steady-state model, which represents the time series data when a fluctuation process of time series data is a non-steady-state process, based on observed past time series data with respective stochastic-differential-equation-models;

a likelihood calculation means that calculates likelihoods, which are values indicating degrees of likelihood of the steady-state model and the non-steady-state model, individually based on observed past time series data;

a mixing ratio calculation means that calculates a mixing ratio of the steady-state model to the non-steady-state model based on the respective likelihoods of the steady-state model and the non-steady-state model; and

a probability distribution prediction means that predicts a probability distribution of time series data based on a prediction model that is obtained by mixing the steady-state model with the non-steady-state model in accordance with the mixing ratio.

### (Supplemental Note 8)

The program according to Supplemental Note 7,

wherein the model identification means identifies the steady-state model with a Vasicek model, and identifies the non-steady-state model with a Brownian motion model.

### (Supplemental Note 9)

A data prediction method, including the steps of:

observing values of time series data;

identifying a steady-state model, which represents the time series data when a fluctuation process of time series data is a steady-state process, and a non-steady-state model, which represents the time series data when a fluctuation process of time series data is a non-steady-state process, based on observed past time series data with respective stochastic-differential-equation-models;

calculating likelihoods, which are values indicating degrees of likelihood of the steady-state model and the non-steady-state model, individually based on observed past time series data;

calculating a mixing ratio of the steady-state model to the non-steady-state model based on the respective likelihoods of the steady-state model and the non-steady-state model; and

predicting a probability distribution of time series data based on a prediction model that is obtained by mixing the steady-state model with the non-steady-state model in accordance with the mixing ratio.

### (Supplemental Note 10)

The data prediction method according to Supplemental Note 9,

wherein the steady-state model is identified with a Vasicek model, and the non-steady-state model is identified with a Brownian motion model.

The afore-described program is stored in a memory device or recorded in a computer-readable recording medium. For example, the recording medium is a portable medium, such as a flexible disk, an optical disk, a magneto-optical disk, and a semiconductor memory.

The present invention was described above through an exemplary embodiment thereof, but the present invention is not limited to the above exemplary embodiment. Various modifications that could be understood by a person skilled in the art may be applied to the configurations and details of the present invention within the scope of the present invention.

The present invention claims the benefits of priority based on Japanese Patent Application No. 2013-051205, filed on Mar. 14, 2013, the entire disclosure of which is incorporated herein by reference.

### REFERENCE SIGNS LIST

1 Data prediction apparatus
11 Data observation unit
12 Steady-state-stochastic-differential-equation-model identification unit
13 Non-steady-state-stochastic-differential-equation-model identification unit
14 Likelihood calculation unit
15 Likelihood ratio test unit
16 Mixing ratio calculation unit
17 Probability distribution prediction unit
100 Data prediction apparatus
101 Data observation means
102 Model identification means
103 Likelihood calculation means
104 Mixing ratio calculation means
105 Probability distribution prediction means

1. A data prediction apparatus, comprising:
a data observation unit that is configured to observe values of time series data;
a model identification unit that is configured to identify a steady-state model and a non-steady-state model with stochastic-differential-equation-models respectively, based on observed past time series data, the steady-state model representing the time series data when a fluctuation process of time series data is a steady-state process, and the non-steady-state model representing the time series data when a fluctuation process of time series data is a non-steady-state process;
a likelihood calculation unit that is configured to calculate likelihoods, which are values indicating degrees of likelihood of the steady-state model and the non-steady-state model, respectively based on observed past time series data;
a mixing ratio calculation unit that is configured to calculate a mixing ratio of the steady-state model to the non-steady-state model based on the respective likelihoods of the steady-state model and the non-steady-state model; and
a probability distribution prediction unit that is configured to predict a probability distribution of time series data based on a prediction model that is obtained by mixing the steady-state model with the non-steady-state model in accordance with the mixing ratio.

2. The data prediction apparatus according to claim 1,
wherein the model identification unit identifies the steady-state model and the non-steady-state model respectively with different stochastic-differential-equation-models.

3. The data prediction apparatus according to claim 1,
wherein the model identification unit identifies the steady-state model with a Vasicek model, and identifies the non-steady-state model with a Brownian motion model.

4. The data prediction apparatus according to claim 1, further comprising:
a test unit that is configured to execute a test for whether observed time series data conform to the steady-state model or the non-steady-state model, based on a ratio of the likelihood of the steady-state model to the likelihood of the non-steady-state model,
wherein the mixing ratio calculation unit calculates the mixing ratio of the steady-state model to the non-steady-state model based on a result of the test.

5. The data prediction apparatus according to claim 4,
wherein the test unit executes a hypothesis test, in the hypothesis test, a hypothesis that observed time series data conform to the non-steady-state model being defined as a null hypothesis, and a hypothesis that observed time series data conform to the steady-state model being defined as an alternative hypothesis.

6. The data prediction apparatus according to claim 4,
wherein, as a result of the test, the mixing ratio calculation unit sets a variable that takes a value of 0 when the observed time series data conform to the steady-state model, and that takes a value of 1 when the observed time series data conform to the non-steady-state model, and
calculates a value by smoothing the variable, as the mixing ratio.

7. A non-transitory computer-readable recording medium that stores a program that allows an information processing device to function as:
a data observation unit that is configured to observe values of time series data;
a model identification unit that is configured to identify a steady-state model and a non-steady-state model with stochastic-differential-equation-models respectively, based on observed past time series data, the steady-state model representing the time series data when a fluctuation process of time series data is a steady-state process, and the non-steady-state model representing the time series data when a fluctuation process of time series data is a non-steady-state process;
a likelihood calculation unit that is configured to calculate likelihoods, which are values indicating degrees of likelihood of the steady-state model and the non-steady-state model, respectively based on observed past time series data;
a mixing ratio calculation unit that is configured to calculate a mixing ratio of the steady-state model to the non-steady-state model based on the respective likelihoods of the steady-state model and the non-steady-state model; and
a probability distribution prediction unit that is configured to predict a probability distribution of time series data based on a prediction model that is obtained by mixing the steady-state model with the non-steady-state model in accordance with the mixing ratio.

8. The non-transitory computer-readable recording medium according to claim 7, wherein the program allows the information processing device to function as:
the model identification unit that identifies the steady-state model with a Vasicek model, and identifies the non-steady-state model with a Brownian motion model.

9. A data prediction method which comprises:
observing values of time series data;
identifying a steady-state model and a non-steady-state model with stochastic differential equation models respectively, based on observed past time series data, the steady-state model representing the time series data when a fluctuation process of time series data is a steady-state process, and the non-steady-state model representing the time series data when a fluctuation process of time series data is a non-steady-state process;
calculating likelihoods, which are values indicating degreed of likelihood of the steady-state model and the non-steady-state model, respectively based on observed past time series data;
calculating a mixing ratio of the steady-state model to the non-steady-state model based on the respective likelihoods of the steady-state model and the non-steady-state model; and
predicting a probability distribution of time series data based on a prediction model that is obtained by mixing the steady-state model with the non-steady-state model in accordance with the mixing ratio.

10. The data prediction method according to claim 9,
wherein the steady-state model is identified with a Vasicek model, and the non-steady-state model is identified with a Brownian motion model.

11. The data prediction apparatus according to claim 2,
wherein the model identification unit identifies the steady-state model with a Vasicek model, and identifies the non-steady-state model with a Brownian motion model.

12. The data prediction apparatus according to claim 2, further comprising:
a test unit that is configured to execute a test for whether observed time series data conform to the steady-state model or the non-steady-state model, based on a ratio of the likelihood of the steady-state model to the likelihood of the non-steady-state model,
wherein the mixing ratio calculation unit calculates the mixing ratio of the steady-state model to the non-steady-state model based on a result of the test.

13. The data prediction apparatus according to claim 3, further comprising:
a test unit that is configured to execute a test for whether observed time series data conform to the steady-state model or the non-steady-state model, based on a ratio of the likelihood of the steady-state model to the likelihood of the non-steady-state model,
wherein the mixing ratio calculation unit calculates the mixing ratio of the steady-state model to the non-steady-state model based on a result of the test.

14. The data prediction apparatus according to claim 11, further comprising:
a test unit that is configured to execute a test for whether observed time series data conform to the steady-state model or the non-steady-state model, based on a ratio of the likelihood of the steady-state model to the likelihood of the non-steady-state model,
wherein the mixing ratio calculation unit calculates the mixing ratio of the steady-state model to the non-steady-state model based on a result of the test.

15. The data prediction apparatus according to claim 12,
wherein the test unit executes a hypothesis test, in the hypothesis test, a hypothesis that observed time series data conform to the non-steady-state model being defined as a null hypothesis, and a hypothesis that observed time series data conform to the steady-state model being defined as an alternative hypothesis.

16. The data prediction apparatus according to claim 13,
wherein the test unit executes a hypothesis test, in the hypothesis test, a hypothesis that observed time series data conform to the non-steady-state model being defined as a null hypothesis, and a hypothesis that observed time series data conform to the steady-state model being defined as an alternative hypothesis.

17. The data prediction apparatus according to claim 14,
wherein the test unit executes a hypothesis test, in the hypothesis test, a hypothesis that observed time series data conform to the non-steady-state model being defined as a null hypothesis, and a hypothesis that observed time series data conform to the steady-state model being defined as an alternative hypothesis.

18. The data prediction apparatus according to claim 15,
wherein, as a result of the test, the mixing ratio calculation unit sets a variable that takes a value of 0 when the observed time series data conform to the steady-state model, and that takes a value of 1 when the observed time series data conform to the non-steady-state model, and
calculates a value by smoothing the variable, as the mixing ratio.

19. The data prediction apparatus according to claim 16,
wherein, as a result of the test, the mixing ratio calculation unit sets a variable that takes a value of 0 when the observed time series data conform to the steady-state model, and that takes a value of 1 when the observed time series data conform to the non-steady-state model, and
calculates a value by smoothing the variable, as the mixing ratio.

20. A data prediction apparatus, comprising:
a data observation means for observing values of time series data;
a model identification means for identifying a steady-state model and a non-steady-state model with stochastic-differential-equation-models respectively, based on observed past time series data, the steady-state model representing the time series data when a fluctuation process of time series data is a steady-state process, and the non-steady-state model representing the time series data when a fluctuation process of time series data is a non-steady-state process;
a likelihood calculation means for calculating likelihoods, which are values indicating degrees of likelihood of the steady-state model and the non-steady-state model, respectively based on observed past time series data;
a mixing ratio calculation means for calculating a mixing ratio of the steady-state model to the non-steady-state model based on the respective likelihoods of the steady-state model and the non-steady-state model; and
a probability distribution prediction means for predicting a probability distribution of time series data based on a prediction model that is obtained by mixing the steady-state model with the non-steady-state model in accordance with the mixing ratio.
